(19) United States
(12) Patent Application Publication
(10) Pub. No.: US 2015/0085533 A1
(43) Pub. Date: Mar. 26, 2015

(54) REACTOR AND POWER CONVERTER

(71) Applicant: Toyota Jidosha Kabushiki Kaisha, Toyota-shi Aichi-ken (JP)

(72) Inventor: Fumiki Tanahashi, Toyota-shi Aichi-ken (JP)

(21) Appl. No.: 14/493,929

(22) Filed: Sep. 23, 2014

(30) Foreign Application Priority Data
Sep. 25, 2013 (JP) 2013-198967

(51) Int. Cl. H01F 38/08; H02M 3/335

(52) U.S. Cl. CPC H01F 38/08; H02M 3/335
USPC 363/17; 336/214

(57) ABSTRACT

A reactor includes a magnetic core; a first coil wound around the magnetic core; a second coil wound around the magnetic core; and a magnetic body that is provided between the first coil and the second coil separate from the magnetic core, and that reduces a coupling coefficient between the first coil and the second coil.

### INCORPORATION BY REFERENCE

The disclosure of Japanese Patent Application No. 2013-198967 filed on Sep. 25, 2013 including the specification, drawings and abstract is incorporated herein by reference in its entirety.

### BACKGROUND OF THE INVENTION

1. Field of the Invention

The invention relates to a reactor and a power converter.

2. Description of Related Art

Japanese Patent Application Publication No. 2005-057925 (JP 2005-057925 A), for example, describes a complex resonant type converter that reduces a coupling coefficient to 0.79, with a gap length of an isolated converter transformer of approximately 1.5 mm.

The structure described in JP 2005-057925 A reduces the coupling coefficient by dimensional control of the gap length between coils.

### SUMMARY OF THE INVENTION

However, with the structure described in JP 2005-057925 A, when a current value applied to the coil is increased, leakage flux consequently increases, so the coupling coefficient decreases. In other words, the coupling coefficient changes with a change in the current value applied to the coil. The invention thus provides a reactor and a power converter capable of reducing the amount of change in the coupling coefficient that accompanies a change in the current value applied to the coil.

A first aspect of the invention relates to a reactor that includes a magnetic core; a first coil wound around the magnetic core; a second coil wound around the magnetic core; and a magnetic body that is provided between the first coil and the second coil separate from the magnetic core, and that reduces a coupling coefficient between the first coil and the second coil.

A second aspect of the invention relates to a power converter that includes a primary side circuit that includes a first reactor including a first magnetic core, a first coil wound around the first magnetic core; a second coil wound around the first magnetic core; and a first magnetic body that is provided between the first coil and the second coil separate from the first magnetic core, and that reduces a coupling coefficient between the first coil and the second coil; and a secondary side circuit that is magnetically coupled to the primary side circuit by a transformer, and includes a second reactor including a second magnetic core, a third coil wound around the second magnetic core; a fourth coil wound around the second magnetic core; and a second magnetic body that is provided between the third coil and the fourth coil separate from the second magnetic core, and that reduces a coupling coefficient between the third coil and the fourth coil.

According to the aspects described above, a reactor and a power converter capable of reducing an amount of change in a coupling coefficient that accompanies a change in a current value applied to a coil are able to be obtained.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram of the structure of a power converter according to a first example embodiment of the invention;

FIG. 2 is a perspective view of a reactor according to the first example embodiment of the invention;

FIG. 3 is a sectional view at a cross-section along a surface that includes a U-shaped plane of a magnetic core element of the reactor;

FIG. 4 is a view of the analysis results of a relationship between a coupling coefficient and current (i.e., current applied to a first coil and a second coil);

FIG. 5A is a view showing the relationship between leakage flux and coupling flux;

FIG. 5B is a view showing the relationship between leakage flux and coupling flux;

FIG. 6 is a view of one example of a mounting method of a magnetic body;

FIG. 7 is a view of another example of a mounting method of the magnetic body;

FIG. 8 is a sectional view of a reactor according to a second example embodiment of the invention; and

FIG. 9 is a sectional view of a reactor according to a third example embodiment of the invention.

### DETAILED DESCRIPTION OF EMBODIMENTS

Hereinafter, example embodiments of the invention will be described in detail with reference to the accompanying drawings.

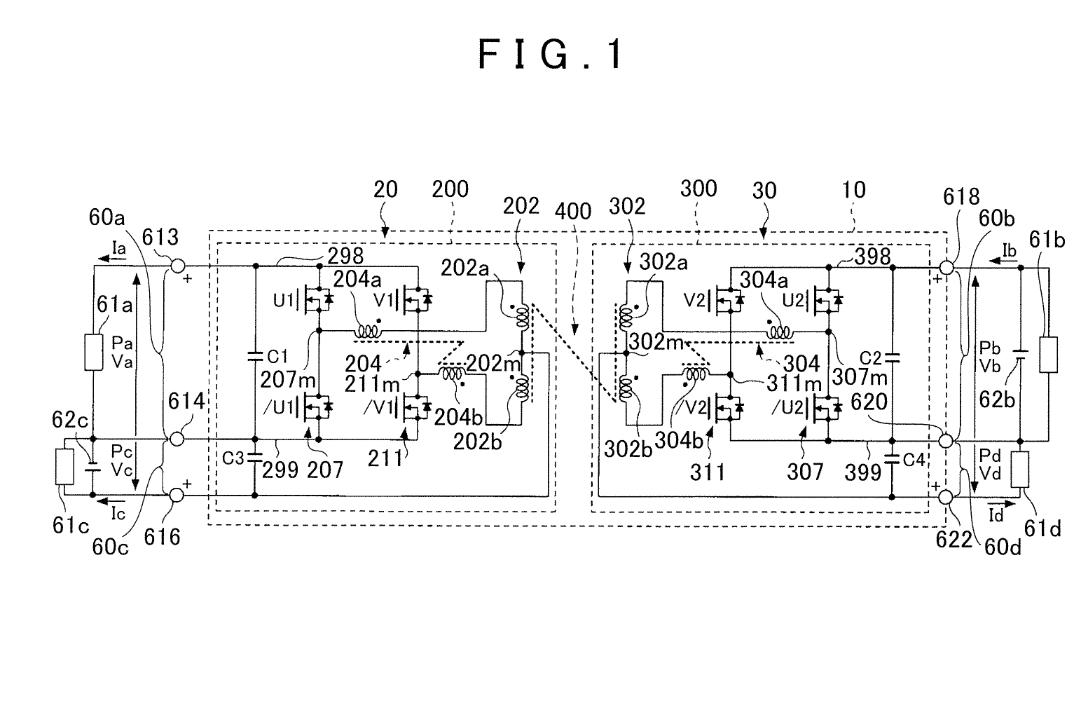

FIG. 1 is a block diagram of the structure of a power converter 10 according to a first example embodiment of the invention. This power converter 10 may be mounted in a vehicle such as an automobile, and may be used by a system that distributes electric power to on-board loads, for example.

The power converter 10 includes, as primary side ports, a first input/output port 60a to which a primary side high-voltage system load 61a is connected, and a second input/output port 60c to which a primary side low-voltage system load 61c and a primary side low-voltage system power supply 62c are connected, for example. The primary side low-voltage system power supply 62c supplies electric power to the primary side low-voltage system load 61c that operates on the same voltage system (such as a 12 V system) as the primary side low-voltage system power supply 62c. Also, the primary side low-voltage system power supply 62c supplies electric power that has been stepped up by a primary side converter circuit 20 provided in the power converter 10, to the primary side high-voltage system load 61a that operates on a different voltage system (such as a 48 V system that is higher than the 12 V system) than the primary side low-voltage system power supply 62c. One specific example of the primary side low-voltage system power supply 62c is a secondary battery such as a lead battery.

The power converter 10 is a power converter circuit that has the four input/output ports described above, and performs power conversion between two ports when any two of the four input/output ports are selected.

Port powers Pa, Pc, Pb, and Pd are input/output powers (input powers or output powers) of the first input/output port 60a, the second input/output port 60c, a third input/output port 60b, and a fourth input/output port 60d, respectively. Port voltages Va, Vc, Vb, and Vd are input/output voltages (input voltages or output voltages) of the first input/output port 60a, the second input/output port 60c, the third input/output port 60b, and the fourth input/output port 60d, respectively. Port currents Ia, Ic, Ib, and Id are input/output currents (input currents or output currents) of the first input/output port 60a, the second input/output port 60c, the third input/output port 60b, and the fourth input/output port 60d, respectively.

The power converter 10 includes a capacitor C1 provided for the first input/output port 60a, a capacitor C3 provided for the second input/output port 60c, a capacitor C2 provided for the third input/output port 60b, and a capacitor C4 provided for the fourth input/output port 60d. Some specific examples of the capacitors C1, C2, C3, and C4 are film capacitors, aluminum electrolytic capacitors, ceramic capacitors, and solid polymer capacitors.

The capacitor C1 is inserted between a terminal 613 on a high-potential side of the first input/output port 60a, and a terminal 614 on a low-potential side of the first input/output port 60a and the second input/output port 60c. The capacitor C3 is inserted between a terminal 616 on a high-potential side of the second input/output port 60c, and the terminal 614 on the low-potential side of the first input/output port 60a and the second input/output port 60c. The capacitor C2 is inserted between a terminal 618 on a high-potential side of the third input/output port 60b, and a terminal 620 on a low-potential side of the third input/output port 60b and the fourth input/output port 60d. The capacitor C4 is inserted between a terminal 622 on a high-potential side of the fourth input/output port 60d, and the terminal 620 on the low-potential side of the third input/output port 60b and the fourth input/output port 60d.

The power converter 10 is a power converter circuit that includes a primary side converter circuit 20 and a secondary side converter circuit 30. The primary side converter circuit 20 and the secondary side converter circuit 30 are connected together via a primary side magnetic coupling reactor 204 and a secondary side magnetic coupling reactor 304, and are magnetically coupled by a transformer 400 (a center-tapped transformer).

The primary side converter circuit 20 is a primary side circuit that includes a primary side full bridge circuit 200, the first input/output port 60a, and the second input/output port 60c. The primary side full bridge circuit 200 is a primary side power converting portion that includes a primary side coil 202 of the transformer 400, the primary side magnetic coupling reactor 204, a primary side first upper arm U1, a primary side first lower arm /U1, a primary side second upper arm V1, and a primary side second lower arm /V1. Here, the primary side first upper arm U1, the primary side first lower arm /U1, the primary side second upper arm V1, and the primary side second lower arm /V1 are all switching elements, each of which includes an N-channel type MOSFET, and a body diode that is a parasitic device of the MOSFET, for example. Diodes may be additionally connected in parallel to the MOSFET.

The primary side full bridge circuit 200 includes a primary side positive bus 298 that is connected to the terminal 613 on the high-potential side of the first input/output port 60a, and a primary side negative bus 299 that is connected to the terminal 614 on the low-potential side of the first input/output port 60a and the second input/output port 60c.

A primary side first arm circuit 207 that series-connects the primary side first upper arm U1 to the primary side first lower arm /U1 is attached between the primary side positive bus 298 and the primary side negative bus 299. This primary side first arm circuit 207 is a primary side first power converter circuit portion (i.e., a primary side U-phase power converter circuit portion) capable of a power converting operation in response to an ON/OFF switching operation of the primary side first upper arm U1 and the primary side first lower arm /U1. Moreover, a primary side second arm circuit 211 that series-connects the primary side second upper arm V1 to the primary side second lower arm /V1 is attached, in parallel to the primary side first arm circuit 207, between the primary side positive bus 298 and the primary side negative bus 299. This primary side second arm circuit 211 is a primary side second power converter circuit portion (i.e., a primary side V-phase power converter circuit portion) capable of a power converting operation in response to an ON/OFF switching operation of the primary side second upper arm V1 and the primary side second lower arm /V1.

The primary side coil 202 and the primary side magnetic coupling reactor 204 are provided on a bridge portion that connects a midpoint 207m of the primary side first arm circuit 207 to a midpoint 211m of the primary side second arm circuit 211. The connections of this bridge portion will now be described in more detail. One end of a primary side first reactor 204a of the primary side magnetic coupling reactor 204 is connected to the midpoint 207m of the primary side first arm circuit 207. Also, one end of the primary side coil 202 is connected to the other end of the primary side first reactor 204a. Moreover, one end of a primary side second reactor 204b of the primary side magnetic coupling reactor 204 is connected to the other end of the primary side coil 202. Then, the other end of the primary side second reactor 204b is connected to the midpoint 211m of the primary side second arm circuit 211. The primary side magnetic coupling reactor 204 includes the primary side first reactor 204a, and the primary side second reactor 204b that is magnetically coupled to the primary side first reactor 204a by a coupling coefficient k₁.

The midpoint 207m is a primary side first intermediate node between the primary side first upper arm U1 and the primary side first lower arm /U1, and the midpoint 211m is a primary side second intermediate node between the primary side second upper arm V1 and the primary side second lower arm /V1.

The first input/output port 60a is a port that is provided between the primary side positive bus 298 and the primary side negative bus 299. The first input/output port 60a includes the terminal 613 and the terminal 614. The second input/output port 60c is a port that is provided between the primary side negative bus 299 and a center tap 202m of the primary side coil 202. The second input/output port 60c includes the terminal 614 and the terminal 616.

The center tap 202m is connected to the terminal 616 on the high-potential side of the second input/output port 60c. The center tap 202m is an intermediate junction point of a primary side first winding 202a and a primary side second winding 202b that are formed by the primary side coil 202.

The secondary side converter circuit 30 is a secondary side circuit that includes a secondary side full bridge circuit 300, the third input/output port 60b, and the fourth input/output port 60d. The secondary side full bridge circuit 300 is a secondary side power converting portion that includes a secondary side coil 302 of the transformer 400, a secondary side magnetic coupling reactor 304, a secondary side first upper arm U2, a secondary side first lower arm /U2, a secondary side second upper arm V2, and a secondary side second lower arm /V2. Here, the secondary side first upper arm U2, the secondary side first lower arm /U2, the secondary side second upper arm V2, and the secondary side second lower arm /V2 are all switching elements, each of which includes an N-channel type MOSFET, and a body diode that is a parasitic device of the MOSFET, for example.

The secondary side full bridge circuit 300 includes a secondary side positive bus 398 that is connected to the terminal 618 on the high-potential side of the third input/output port 60b, and a secondary side negative bus 399 that is connected to the terminal 620 on the low-potential side of the third input/output port 60b and the fourth input/output port 60d.

A secondary side first arm circuit 307 that series-connects the secondary side first upper arm U2 to the secondary side first lower arm /U2 is attached between the secondary side positive bus 398 and the secondary side negative bus 399. This secondary side first arm circuit 307 is a secondary side first power converter circuit portion (i.e., a secondary side U-phase power converter circuit portion) capable of a power converting operation in response to an ON/OFF switching operation of the secondary side first upper arm U2 and the secondary side first lower arm /U2. Moreover, a secondary side second arm circuit 311 that series-connects the secondary side second upper arm V2 to the secondary side second lower arm /V2 is attached, in parallel to the secondary side first arm circuit 307, between the secondary side positive bus 398 and the secondary side negative bus 399. This secondary side second arm circuit 311 is a secondary side second power converter circuit portion (i.e., a secondary side V-phase power converter circuit portion) capable of a power converting operation in response to an ON/OFF switching operation of the secondary side second upper arm V2 and the secondary side second lower arm /V2.

The secondary side coil 302 and the secondary side magnetic coupling reactor 304 are provided on a bridge portion that connects a midpoint 307m of the secondary side first arm circuit 307 to a midpoint 311m of the secondary side second arm circuit 311. The connections of this bridge portion will now be described in more detail. One end of a secondary side first reactor 304a of the secondary side magnetic coupling reactor 304 is connected to the midpoint 307m of the secondary side first arm circuit 307. Also, one end of the secondary side coil 302 is connected to the other end of the secondary side first reactor 304a. Moreover, one end of a secondary side second reactor 304b of the secondary side magnetic coupling reactor 304 is connected to the other end of the secondary side coil 302. Then, the other end of the secondary side second reactor 304b is connected to the midpoint 311m of the secondary side second arm circuit 311. The secondary side magnetic coupling reactor 304 includes the secondary side first reactor 304a, and the secondary side second reactor 304b that is magnetically coupled to the secondary side first reactor 304a by a coupling coefficient k₂.

The midpoint 307m is a secondary side first intermediate node between the secondary side first upper arm U2 and the secondary side first lower arm /U2, and the midpoint 311m is a secondary side second intermediate node between the secondary side second upper arm V2 and the secondary side second lower arm /V2.

The third input/output port 60b is a port that is provided between the secondary side positive bus 398 and the secondary side negative bus 399. The third input/output port 60b includes the terminal 618 and the terminal 620. The fourth input/output port 60d is a port that is provided between the secondary side negative bus 399 and a center tap 302m of the secondary side coil 302. The fourth input/output port 60d includes the terminal 620 and the terminal 622.

The center tap 302m is connected to the terminal 622 on the high-potential side of the fourth input/output port 60d. The center tap 302m is an intermediate junction point of a secondary side first winding 302a and a secondary side second winding 302b that are formed by the secondary side coil 302.

Here, a voltage step-up/down function of the primary side converter circuit 20 will be described. Focusing on the second input/output port 60c and the first input/output port 60a, the terminal 616 of the second input/output port 60c is connected to the midpoint 207m of the primary side first arm circuit 207 via the primary side first winding 202a and the primary side first reactor 204a that is series-connected to the primary side first winding 202a. Also, both ends of the primary side first arm circuit 207 are connected to the first input/output port 60a, so a voltage step-up/down circuit is attached between the terminal 616 of the second input/output port 60c and the first input/output port 60a.

Furthermore, the terminal 616 of the second input/output port 60c is connected to the midpoint 211m of the primary side second arm circuit 211 via the primary side second winding 202b and the primary side second reactor 204b that is series-connected to the primary side second winding 202b. Also, both ends of the primary side second arm circuit 211 are connected to the first input/output port 60a, so a voltage step-up/down circuit is attached in parallel between the terminal 616 of the second input/output port 60c and the first input/output port 60a. The secondary side converter circuit 30 is a circuit having substantially the same structure as the primary side converter circuit 20, so two voltage step-up/down circuits are connected in parallel between the terminal 622 of the fourth input/output port 60d and the third input/output port 60b. Therefore, the secondary side converter circuit 30 has a voltage step-up/down function similar to the primary side converter circuit 20.

Next, a reactor of the invention will be described. The reactor described below is able to preferably be used in the power converter 10 described above. For example, the reactor may be used as the primary side magnetic coupling reactor 204, or as the secondary side magnetic coupling reactor 304. In the description below, the reactor will be described as one that forms the primary side magnetic coupling reactor 204, as an example.

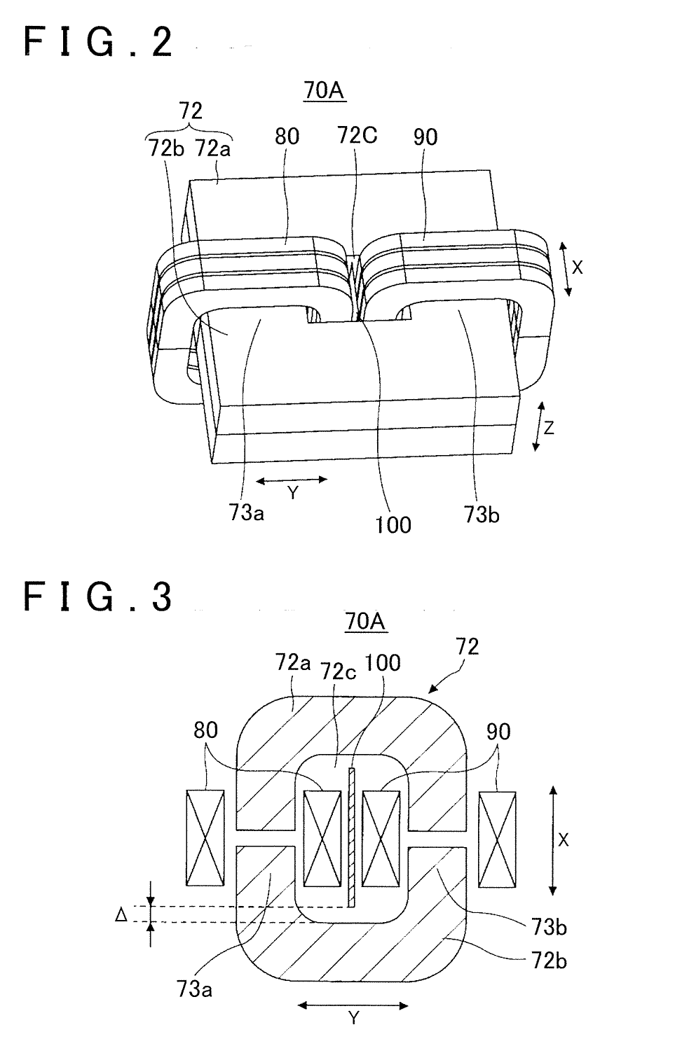

FIG. 2 is a perspective view of a reactor 70A according to one example embodiment (a first example embodiment) of the invention. FIG. 3 is a sectional view of the reactor 70A (i.e., a sectional view in a direction in which a cross-section of magnetic core elements 72a and 72b is U-shaped).

The reactor 70A includes a magnetic core 72, a first coil 80, a second coil 90, and a magnetic body 100.

The magnetic core 72 may be made of any suitable magnetic material (such as material that includes iron oxide such as ferrite). In the example shown in FIG. 2, the magnetic core 72 includes two magnetic core elements 72a and 72b. These magnetic core elements 72a and 72b are both U-shaped cores, and are arranged facing each other in a manner in which a slot 72c is formed. In this structure, identical parts are able to be used for these magnetic core elements 72a and 72b. The magnetic core 72 may be formed by combining a U-shaped core with an I-shaped core, or it may be a ring-shaped core. Also, the magnetic core 72 may be a core that is formed by punching, or it may be a laminated core.

The first coil 80 is wound around a first leg portion 73a of the magnetic core 72, in a manner passing through the slot 72c. In this case, the first leg portion 73a defines a first axis around which the first coil 80 is wound. The second coil 90 is wound around a second leg portion 73b of the magnetic core 72, in a manner passing through the slot 72c. The second leg portion 73b defines a second axis around which the second coil 90 is wound. In the description below, the X direction corresponds to a direction parallel to the first axis and the second axis.

The first coil 80 and the second coil 90 are typically made of the same material. The first coil 80 and the second coil 90 are each preferably formed by flat wire having a rectangular cross-section that is able to handle a larger current than thin round wire having a round cross-section. However, the first coil 80 and the second coil 90 may also each be formed by thin round wire having a round cross-section. Also, the first coil 80 and the second coil 90 may each have a single-layer winding structure, or a multi-layer winding structure.

The magnetic body 100 may be made of any suitable magnetic material (such as material that includes iron oxide such as ferrite). The magnetic body 100 is provided between the first coil 80 and the second coil 90 in a Y direction. The Y direction is a perpendicular to an extending direction (i.e., the X direction) of the first leg portion 73a (and the second leg portion 73b) in a U-shaped plane of the magnetic core elements 72a and 72b. The magnetic body 100 has a function of reducing the coupling coefficient between the first coil 80 and the second coil 90. The shape of the magnetic body 100 may be any suitable shape and is not limited to having the function of reducing the coupling coefficient between the first coil 80 and the second coil 90. In the example shown in FIG. 2, the magnetic body 100 is a flat plate-shaped member (a flat plate in which the Y direction is a normal line), and is arranged in the slot 72c of the magnetic core 72. When the magnetic body 100 is a flat plate-shaped member, the plate thickness may be approximately 0.1 mm, for example. The extending range of the magnetic body 100 in a Z direction is arbitrary. For example, the magnetic body 100 may extend inside the slot 72c between both end surfaces of the magnetic core 72 in the Z direction (see FIG. 2), or may extend in a manner protruding out in the Z direction from both end surfaces of the magnetic core 72 in the Z direction, or may extend in a manner staying further to the inside in the Z direction than both end surfaces of the magnetic core 72 in the Z direction.

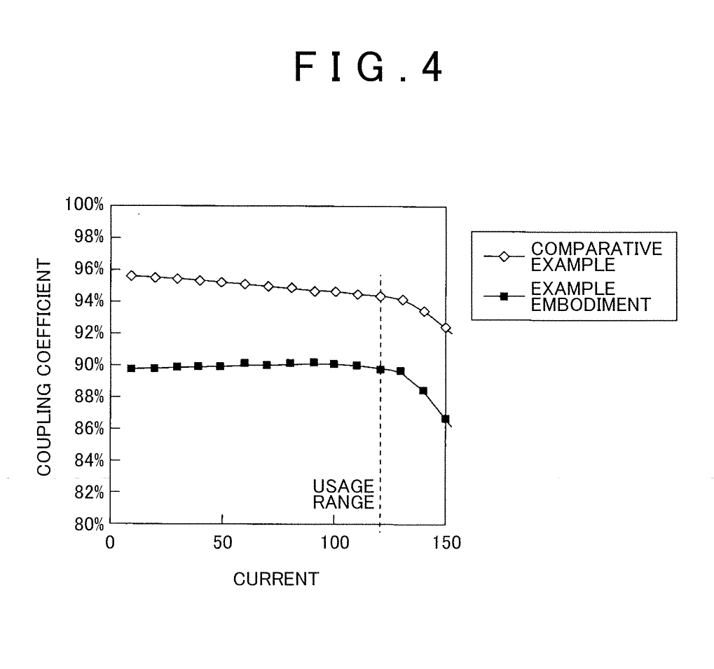

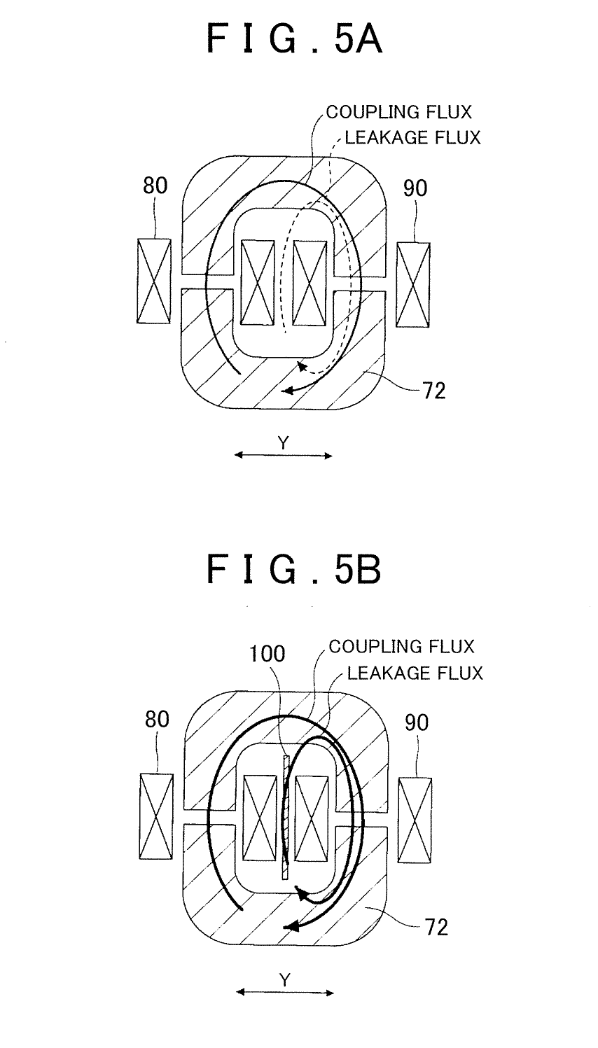

FIG. 4 is a view of the analysis results of a relationship between a coupling coefficient and current (i.e., current applied to the first coil 80 and the second coil 90). FIGS. 5A and 5B are views illustrating the relationship between leakage flux and coupling flux when the second coil 90 is energized. FIG. 5A is a view of a case of a comparative example, and FIG. 5B is a view of a case with the example embodiment. FIG. 4 is a view showing the analysis results based on CAE (computer-aided engineering) analysis by the inventor. FIG. 4 is also a view showing the analysis results of the comparative example for comparison. The comparative example is formed without the magnetic body 100. That is, the comparative example has the same structure of the reactor 70A minus the magnetic body 100. The coupling coefficient indicates the percentage at which magnetic flux generated by one coil links to the other coil. Here, the relationship between the leakage flux and the coupling flux when the second coil 90 is energized is described. The relationship between the leakage flux and the coupling flux when the first coil 80 is energized is essentially the same.

With the comparative example, when a relatively low current is applied to the second coil 90, coupling flux is generated, as shown in the frame format in FIG. 5A. At this time, with the comparative example, there is an air gap between the first coil 80 and the second coil 90 in the Y direction, as shown in FIG. 5A, so the leakage flux that flows through this air gap is small (shown in a frame format by the dotted line). Therefore, with the comparative example, the coupling coefficient is relative high (approximately 96%), as shown in FIG. 4.

On the other hand, with the example embodiment, when a relatively low current is applied to the second coil 90, coupling flux and leakage flux are generated, as shown in the frame format in FIG. 5B. With the example embodiment, the magnetic body 100 is provided between the first coil 80 and the second coil 90 in the Y direction, as shown in FIG. 5B, so the magnetic body 100 forms a magnetic path such that the leakage flux increases. Therefore, with this example embodiment, the coupling coefficient is relatively low (approximately 90%), as shown in FIG. 4. In this way, with the example embodiment, the coupling coefficient in the low current region is able to be reduced compared to the comparative example, by providing the magnetic body 100 between the first coil 80 and the second coil 90 in the Y direction. This kind of low coupling coefficient is especially preferable when the primary side magnetic coupling reactor 204 is to have a current filter function.

Also, with the comparative example, when the current applied to the second coil 90 is increased, the percentage of magnetic flux (leakage flux) that passes through the air gradually increases (the percentage of magnetic flux flowing through the magnetic core 72 gradually decreases), so the coupling coefficient decreases, as shown in FIG. 4. For example, with the example shown in FIG. 4, the coupling rate changes (i.e., decreases) by more than 1% when the current is increased to the maximum value (see the dotted line) of the usage range.

On the other hand, with the example embodiment, when the current applied to the second coil 90 is increased, the percentage of magnetic flux that flows through the magnetic core 72 and the percentage of magnetic flux that flows through the magnetic body 100 both increase, so the coupling coefficient remains substantially constant, as shown in FIG. 4. That is, the increase in the percentage of leakage flux of the magnetic core 72 is cancelled out by the decrease in the percentage in the magnetic flux flowing through the magnetic body 100, so the coupling coefficient remains substantially constant. As a result, with the example embodiment, the coupling coefficient is able to be made constant from the low current region to the high current region (throughout the entire region of the usage range). The term “constant” here means not strictly constant, but rather that fluctuation is kept within a range of less than 1% (see FIG. 4).

The characteristics shown in FIG. 4 rely on the makeup of the magnetic core 72 (e.g., the current value at the time of magnetic saturation), the magnetic saturation characteristic of the magnetic body 100 (e.g., the current value at the time of magnetic saturation), and the amount of clearance A (see FIG. 3) in the X direction between the magnetic core 72 and the magnetic body 100, and the like. Therefore, characteristics (i.e., the relationship between current and the coupling coefficient) such as the coupling coefficient being constant throughout the entire region of the usage range may also be realized by adjusting the amount of clearance A, for example. The magnetic body 100 becomes saturated faster (i.e., the current value at the time of magnetic saturation becomes lower) the smaller the clearance A is in the X direction between the magnetic core 72 and the magnetic body 100.

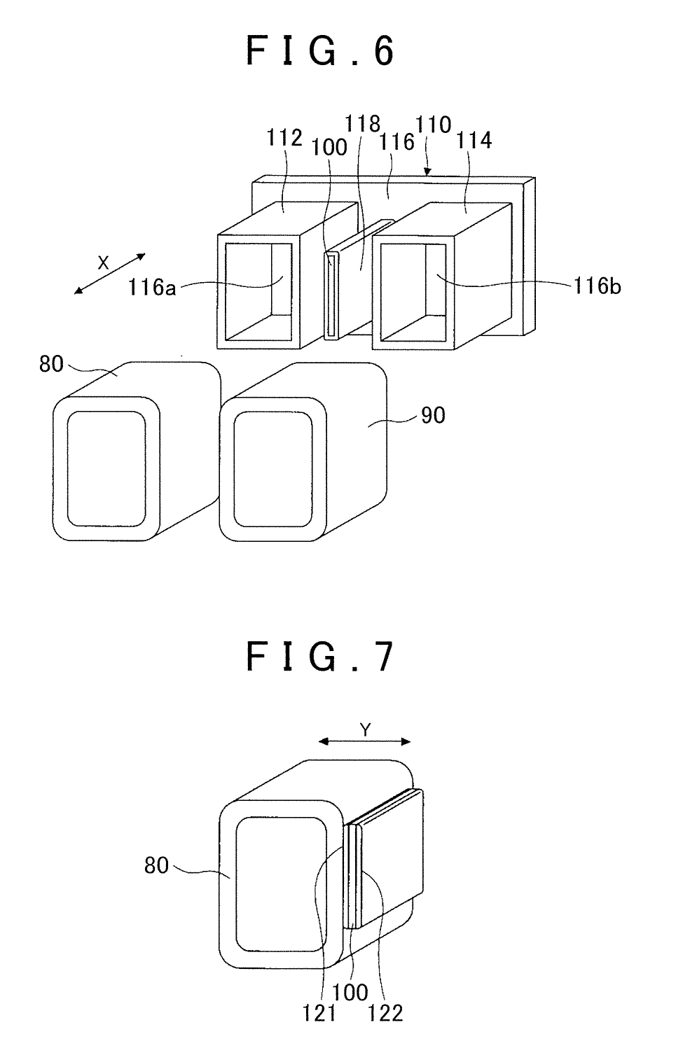

FIG. 6 is a view of an example of a mounting method of the magnetic body 100.

In the example shown in FIG. 6, the magnetic body 100 is integrally formed (insert molded) with a bobbin 110. A resin portion of the bobbin 110 includes a first coil retaining portion 112, a second coil retaining portion 114, a base portion 116, and a covering portion 118. The first coil retaining portion 112 and the second coil retaining portion 114 stand erect on the base portion 116 in a manner extending in the X direction. The first coil retaining portion 112 and the second coil retaining portion 114 both have a hollow cylindrical shape. Through-holes 116a and 116b corresponding to the hollow portions of the first coil retaining portion 112 and the second coil retaining portion 114 are formed in the base portion 116. The covering portion 118 covers the magnetic body 100. The first coil 80 and the second coil 90 are wound around the outer peripheries of the first coil retaining portion 112 and the second coil retaining portion 114, respectively. Also, the first leg portion 73a and the second leg portion 73b of the magnetic core 72 are inserted into the hollow portions of the first coil retaining portion 112 and the second coil retaining portion 114, respectively.

Only one bobbin 110 may be used in one reactor 70A, or two bobbins 110 may be used in one reactor 70A. When two bobbins 110 are used, the two bobbins 110 may be arranged opposing one another with the base portions 116 aligned in the X direction. In this case, the magnetic core elements 72a and 72b are both attached from both sides of the two bobbins 110 in the X direction.

FIG. 7 is a view of another example of the mounting method of the magnetic body 100.

The magnetic body 100 may be affixed to either one of the coils, i.e., the first coil 80 or the second coil 90, by adhesive or tape or the like. In the example shown in FIG. 7, the magnetic body 100 is affixed to the outer peripheral surface of the first coil 80 (i.e., the outer peripheral surface opposing the second coil 90 in the Y direction). Insulating layers 121 and 122 are formed on both surfaces of the magnetic body 100 in the Y direction. The insulating layers 121 and 122 may be formed by applying a resin coating or tape-like insulating material having a thickness of 10 μm or more, for example. If the magnetic body 100 is affixed to the outer peripheral surface of the first coil 80 with tape, the insulating layer 121 may be omitted.

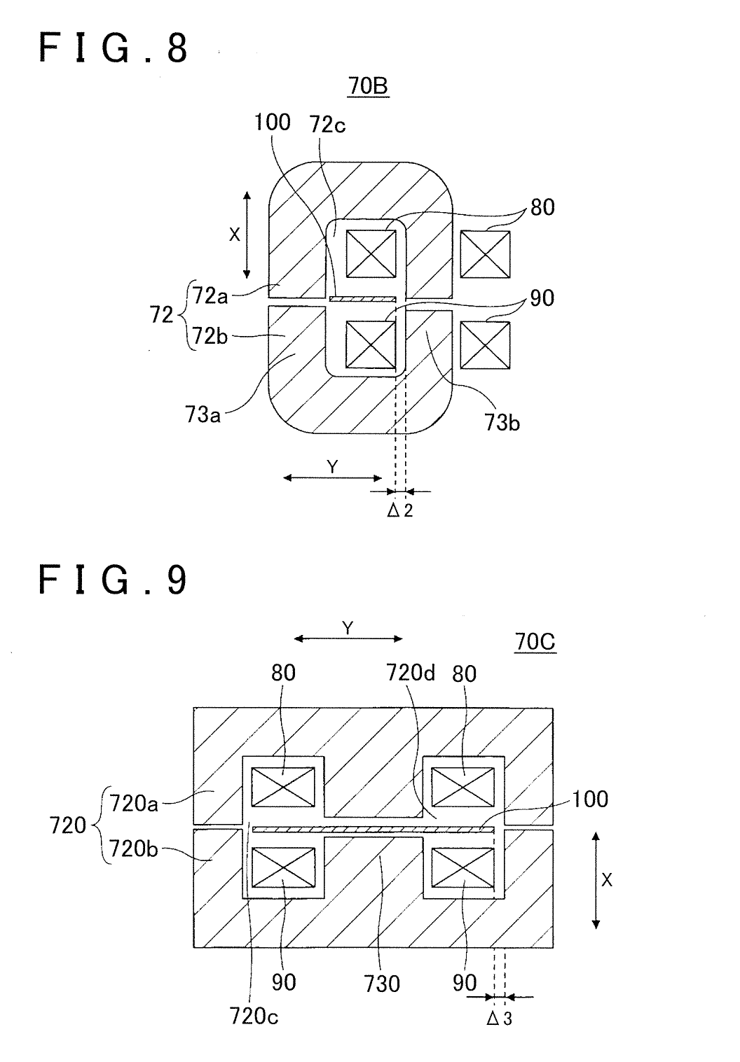

FIG. 8 is a sectional view of a reactor 70B according to another example embodiment (a second example embodiment) of the invention, and corresponds to FIG. 3 of the first example embodiment described above.

The reactor 70B differs from the reactor 70A in the first example embodiment described above, in terms of the arrangement of the first coil 80 and the second coil 90. Accordingly, the manner in which the magnetic body 100 is arranged differs from that of the first example embodiment described above. The other structure may be the same as it is in the first example embodiment.

More specifically, the first coil 80 is wound around the second leg portion 73b of the magnetic core 72 in a manner passing through the slot 72c. The second coil 90 is also wound around the second leg portion 73b of the magnetic core 72 in a manner passing through the slot 72c. The first coil 80 and the second coil 90 are wound around the same axis, separated in the X direction. In the example shown in FIG. 8, the first coil 80 and the second coil 90 are wound around the second leg portion 73b of the magnetic core 72, but they may also be wound around the first leg portion 73a.

The magnetic body 100 is provided between the first coil 80 and the second coil 90 in the X direction. In the example shown in FIG. 8, the magnetic body 100 is similarly arranged inside the slot 72c of the magnetic core 72. The magnetic body 100 has a flat plate shape with the X axis being a normal line. The magnetic body 100 has a function of reducing the coupling coefficient between the first coil 80 and the second coil 90, as described in the first example embodiment described above.

The reactor 70B according to the second example embodiment is also able to obtain effects similar to those obtained by the reactor 70A according to the first example embodiment described above. That is, with the second example embodiment, a change in the coupling coefficient with respect to a change in the energizing current is able to be suppressed, while the coupling coefficient is reduced, by providing the magnetic body 100 between the first coil 80 and the second coil 90. As a result, the coupling coefficient is able to be made constant from the low current region to the high current region (i.e., throughout the entire region of the usage range).

In the second example embodiment as well, characteristics (the relationship between the current and the coupling coefficient) such as the coupling coefficient being constant throughout the entire region of the usage range may also be realized by adjusting the amount of clearance 42 (clearance in the Y direction between the magnetic body 100 and the magnetic core 72), for example.

FIG. 9 is a sectional view of a reactor 70C according to yet another example embodiment (a third example embodiment) of the invention, and corresponds to FIG. 3 in the first example embodiment described above.

The reactor 70C differs from the reactor 70A in the first example embodiment described above mainly in that a magnetic core 720 is formed by an E-shaped core. Accordingly, the manners in which the first coil 80, the second coil 90, and the magnetic body 100 are arranged are different than they are in the first example embodiment described above. The other structure may be the same as it is in the first example embodiment.

The magnetic core 720 includes two magnetic core elements 720a and 720b. The magnetic core elements 720a and 720b are both E-shaped cores, and are arranged facing each other in a manner in which two slots 720c and 720d are formed. In this structure, identical parts are able to be used for these magnetic core elements 720a and 720b. The magnetic core 720 may also be formed by combining an E-shaped core with an I-shaped core (i.e., the magnetic core 720 may be an EI-shaped core). Also, the magnetic core 720 may be a core that is formed by punching, or it may be a laminated core.

The first coil 80 and the second coil 90 are wound around a center leg portion 730 of the magnetic core 720, in a manner passing through the two slots 720c and 720d. The first coil 80 and the second coil 90 are wound around the same axis, separated in the X direction.

The magnetic body 100 is provided between the first coil 80 and the second coil 90 in the X direction. In the example shown in FIG. 9, the magnetic body 100 is similarly arranged in the slots 720c and 720d of the magnetic core 720. In the example shown in FIG. 9, the magnetic body 100 has a flat plate shape with the X direction being a normal line. The magnetic body 100 has a function of reducing the coupling coefficient between the first coil 80 and the second coil 90, as described in the first example embodiment described above.

The reactor 70C according to the third example embodiment is also able to obtain effects similar to those obtained by the reactor 70A according to the first example embodiment described above. That is, with the third example embodiment, a change in the coupling coefficient with respect to a change in the energizing current is able to be suppressed, while the coupling coefficient is reduced, by providing the magnetic body 100 between the first coil 80 and the second coil 90. As a result, the coupling coefficient is able to be made constant from the low current region to the high current region (i.e., throughout the entire region of the usage range).

In the third example embodiment as well, characteristics (the relationship between the current and the coupling coefficient) such as the coupling coefficient being constant throughout the entire region of the usage range may also be realized by adjusting the amount of clearance 43 (clearance in the Y direction between the magnetic body 100 and the magnetic core 720), for example.

Heretofore, various example embodiments have been described in detail, but they are not limited to the specific example embodiments. Various modifications and changes are also possible. Also, all or a plurality of the constituent elements of the example embodiments described above may be combined.

For example, the reactors 70A and 70B according to the example embodiments described above may be used not only as magnetic coupling reactors in the power converter 10 having the structure illustrated, but also as magnetic coupling reactors in a power converter having another structure. Also, the reactors 70A and 70B according to the example embodiments described above may also be used as transformers.

What is claimed is:

1. A reactor comprising:
a magnetic core;
a first coil wound around the magnetic core;
a second coil wound around the magnetic core; and
a magnetic body that is provided between the first coil and the second coil separate from the magnetic core, and that reduces a coupling coefficient between the first coil and the second coil.

2. The reactor according to claim 1, wherein
the magnetic body forms a magnetic path such that a portion of magnetic flux formed when the first coil is energized will not flow into the second coil.

3. The reactor according to claim 1, wherein
the magnetic core defines a first axis and a second axis that are parallel to each other;
the first coil is wound around the first axis;
the second coil is wound around the second axis; and
the magnetic body is provided between the first coil and the second coil in a direction perpendicular to the first axis.

4. The reactor according to claim 3, wherein
a gap is formed between the magnetic body and the magnetic core in a direction parallel to the first axis and the second axis.

5. The reactor according to claim 4, wherein
a size of the gap is formed such that the coupling coefficient remains constant while energizing current when the first coil is being energized is within a predetermined range.

6. The reactor according to claim 1, wherein
the first coil and the second coil are wound around the same axis, separated from each other in an axial direction, and the magnetic body is provided between the first coil and the second coil in the axial direction.

7. A power converter comprising:
a primary side circuit that includes a first reactor including a first magnetic core, a first coil wound around the first magnetic core; a second coil wound around the first magnetic core; and a first magnetic body that is provided between the first coil and the second coil separate from the first magnetic core, and that reduces a coupling coefficient between the first coil and the second coil; and
a secondary side circuit that is magnetically coupled to the primary side circuit by a transformer, and includes a second reactor including a second magnetic core, a third coil wound around the second magnetic core; a fourth coil wound around the second magnetic core; and a second magnetic body that is provided between the third coil and the fourth coil separate from the second magnetic core, and that reduces a coupling coefficient between the third coil and the fourth coil.
